(19) United States
(12) Patent Application Publication
(10) Pub. No.: US 2025/0160593 A1
(43) Pub. Date: May 22, 2025

(54) CLEANER FOR ADJUSTING SUCTION POWER, AND CONTROL METHOD THEREFOR

(71) Applicant: Samsung Electronics Co., Ltd., Suwon-si (KR)

(72) Inventors: Jinwoo CHO, Suwon-si (KR); Seungmoo LIM, Suwon-si (KR); Woong HWANG, Suwon-si (KR)

(21) Appl. No.: 19/034,016

(22) Filed: Jan. 22, 2025

Related U.S. Application Data
(63) Continuation of application No. PCT/KR2023/007462, filed on May 31, 2023.

(30) Foreign Application Priority Data
Aug. 10, 2022 (KR) 10-2022-0100156

(51) Int. Cl. A47L 9/28

(52) U.S. Cl. CPC A47L 9/2842; A47L 9/2821; A47L 9/2826; A47L 9/2831; A47L 9/2847; A47L 9/2857

(57) ABSTRACT

A cleaner is provided. The cleaner includes a pressure sensor, a current sensor, a suction motor, a brush motor, memory, comprising one or more storage media, storing instructions, and one or more processors coupled to the pressure sensor, the current sensor, and the memory, wherein the instructions, when executed by the one or more processors individually or collectively, cause the cleaner to obtain a suction pressure value of air sucked into the cleaner from the pressure sensor, obtain a driving current value of the brush motor from the current sensor, determine whether the cleaner has been lifted up from a floor based on the suction pressure value and the driving current value, and decrease suction power of the cleaner by decreasing a rotation speed of the suction motor according to a determination that the cleaner has been lifted up from the floor for a reference time or more.

### CROSS-REFERENCE TO RELATED APPLICATION(S)

This application is a continuation application, claiming priority under § 365 (c), of an International application No. PCT/KR2023/007462, filed on May 31, 2023, which is based on and claims the benefit of a Korean patent application number 10-2022-0100156, filed on Aug. 10, 2022, in the Korean Intellectual Property Office, the disclosure of which is incorporated by reference herein in its entirety.

### BACKGROUND

### 1. Field

The disclosure relates to a cleaner, a cleaner control method, and a computer-readable recording medium storing a computer program for performing the cleaner control method. More particularly, the disclosure relates to a cleaner for adjusting suction power based on a suction pressure value.

### 2. Description of Related Art

Suction power required for cleaners to suck up dust from a floor depends on the type of the floor. For example, cleaners can easily suck up dust from a floor made of wood, cement or marble, with low suction power. However, in the case of a floor made of a smooth material, such as floor paper or a mat, which can be detached from the actual floor (for example, a floor constructed of wood, etc.), the suction ports of cleaners may become stuck to the floor at high suction power, which makes cleaning impossible. Also, in the case in which the floor is a carpet, dust on the carpet may not be easily sucked up at low suction power.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide to a cleaner for adjusting suction power based on a suction pressure value.

Additional aspects will be set forth in part in the description which follows and, in part, will be apparent from the description, or may be learned by practice of the presented embodiments.

In accordance with an aspect of the disclosure, a cleaner is provided. The cleaner includes a pressure sensor, a current sensor, a suction motor, a brush motor, memory, comprising one or more storage media, storing instructions, and one or more processors coupled to the pressure sensor, the current sensor, and the memory, wherein the instructions, when executed by the one or more processors individually or collectively, cause the cleaner to obtain a suction pressure value of air sucked into the cleaner from the pressure sensor, detect a driving current value of the brush motor from the current sensor, determine whether the cleaner has been lifted up from a floor based on the suction pressure value and the driving current value, and decrease suction power of the cleaner by decreasing a rotation speed of the suction motor according to a determination that the cleaner has been lifted up from the floor for a reference time or more.

In accordance with another aspect of the disclosure, a method performed by a cleaner is provided. The method includes detecting a suction pressure value of air sucked into the cleaner, detecting a driving current value of a brush motor of the cleaner, determining whether the cleaner has been lifted up from a floor based on the suction pressure value and the driving current value, and decreasing suction power of the cleaner by decreasing a rotation speed of the suction motor of the cleaner according to a determination that the cleaner has been lifted up from the floor for a reference time or more.

In accordance with another aspect of the disclosure, one or more non-transitory computer-readable storage media storing one or more computer programs including computer-executable instructions that, when executed by one or more processors of a cleaner individually or collectively, cause the cleaner to perform operations are provided. The operations include detecting a suction pressure value of air sucked into the cleaner, detecting a driving current value of a brush motor of the cleaner, determining whether the cleaner has been lifted up from a floor based on the suction pressure value and the driving current value, and decreasing suction power of the cleaner by decreasing a rotation speed of the suction motor of the cleaner according to a determination that the cleaner has been lifted up from the floor for a reference time or more.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 shows a method, performed by a cleaner, of changing suction power according to a type of a floor, according to an embodiment of the disclosure;

FIG. 2 shows a block diagram of a cleaner according to an embodiment of the disclosure;

FIG. 3 is a diagram showing parts of a cleaner according to an embodiment of the disclosure;

FIG. 4 shows a method, performed by a cleaner, of controlling a suction motor to increase or decrease suction power, according to an embodiment of the disclosure;

FIGS. 5A and 5B show a method, performed by a cleaner, of controlling a suction motor to increase suction power, according to various embodiments of the disclosure;

FIG. 6 shows a method, performed by a cleaner, of identifying a type of a floor based on suction pressure and consumption power of a brush motor, according to an embodiment of the disclosure;

FIG. 7 is a flowchart illustrating a method, performed by a cleaner, of adjusting suction power according to a type of a floor, according to an embodiment of the disclosure;

FIG. 8 shows a method, performed by a cleaner, of displaying an identified type of a floor, according to an embodiment of the disclosure;

FIG. 9 shows a method, performed by a cleaner, of providing a guide user interface (UI) for setting a suction power automatic mode, according to an embodiment of the disclosure;

FIG. 10 shows a method, performed by a cleaner, of displaying a guide UI for guiding a change of suction power of the cleaner according to a type of a floor, according to an embodiment of the disclosure;

FIG. 11 is a flowchart illustrating a method, performed by a cleaner, of changing a strength of suction power based on a pattern of suction pressure according to a user's operation, according to an embodiment of the disclosure;

FIG. 12 shows a method, performed by a cleaner, of temporarily changing a strength of suction power based on a pattern of suction pressure according to a user's operation, according to an embodiment of the disclosure; and

FIG. 13 shows a block diagram of a cleaner according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In the disclosure, the expression “at least one of a, b or c” indicates “a,” “b,” “c,” “a and b,” “a and c,”” “b and c,” “all of a, b, and c,” or variations thereof.

Although general terms being widely used were selected as terminology used in the disclosure while considering the functions mentioned in the disclosure, they may vary according to the intentions of engineers engaged in the art, judicial precedents, the advent of new technologies, and the like. Hence, the terms used in the disclosure must be interpreted based on the meanings of the terms and the contents of the entire specification, not by simply stating the terms themselves.

It will be understood that, although the terms “first,” “second,” etc. may be used herein to describe various components, these components should not be limited by these terms. These terms are only used to distinguish one component from another.

Also, the terms used in the disclosure are used to describe specific embodiments, not for the purpose of limiting the disclosure. In this specification, it will be understood that the case in which a certain portion is “connected” to another portion includes the case in which the portion is “electrically connected” to the other portion with another device in between, as well as the case in which the portion is “directly connected” to the other portion. Also, it will be understood that when a certain portion “includes” a certain component, the portion does not exclude another component but can further include another component, unless the context clearly dictates otherwise.

In this specification, the phrases “some embodiments,” “an embodiment,” etc. as used in various places in this specification do not necessarily indicate the same embodiment.

Embodiments of the disclosure provide a cleaner for automatically adjusting suction power according to a type of a floor on which a cleaner head is placed, and a control method thereof.

Also, embodiments of the disclosure provide a cleaner for controlling a suction motor by a method corresponding to an increase or decrease of suction power, and a control method thereof.

Also, embodiments of the disclosure provide a cleaner for changing suction power based on a pattern of suction pressure input by a user's operation, and a control method thereof.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

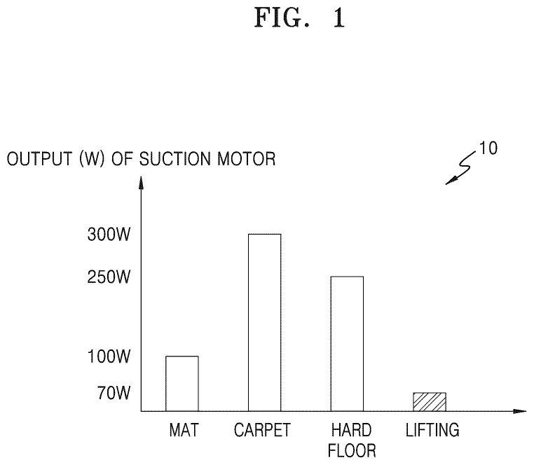

FIG. 1 shows a method of changing suction power according to a type of a floor, performed by a cleaner, according to an embodiment of the disclosure.

Referring to FIG. 1, a cleaner 1000 may identify a type of a floor on which a cleaner head is placed. For example, the cleaner 1000 may identify the type of the floor based on suction pressure and driving current of a brush motor. Also, the cleaner 1000 may identify the type of the floor based on at least one of suction pressure, driving current of the brush motor, or an amount of sucked dust.

For example, according to suction pressure being within a reference range or high driving current of the brush motor, the cleaner 1000 may identify the type of the floor as a carpet. Also, according to suction pressure exceeding the reference range, the cleaner 1000 may identify the type of the floor as a mat. Also, according to detected suction pressure being below the reference range, the cleaner 1000 may identify the type of the floor as lifting which is a state in which a suction port of a cleaner head is located above the floor without contacting the floor.

Types of floors may include a mat, a carpet, a hard floor, and lifting (when the cleaner is lifted up), although not limited thereto. For example, types of floors may further include bedclothes, a wood floor, etc.

The cleaner 100 may change suction power according to the identified type of the floor. A graph 10 of FIG. 1 represents target outputs of the suction motor, stored in advance in the cleaner 1000 according to types of floors. The cleaner 1000 may change suction power according to the identified type of the floor based on the stored target outputs of the suction motor. For example, when the type of the floor is a mat and adsorption occurs, the cleaner 1000 may decrease suction power. Also, when the type of the floor is a carpet and a set strength of suction power is below a reference value corresponding to the carpet, the cleaner 100 may increase the suction power to the reference value corresponding to the carpet or more. Also, when the cleaner 1000 is identified to have been lifted up, the cleaner 1000 may decrease suction power to a value corresponding to a lifted-up state. The cleaner 1000 may adjust suction power according to a type of a floor, thereby providing an efficient cleaning function and reducing unnecessary energy consumption.

Also, when the cleaner 1000 changes suction power according to a type of a floor, the cleaner 1000 may consider a user's intention. For example, the cleaner 1000 may display a guide user interface (UI) for guiding a change of suction power, and change suction power based on a user input of selecting a change. Also, when a frequency with which a user changes suction power increases, the cleaner 1000 may display a guide UI for guiding setting of an automatic mode of automatically adjusting suction power, and change suction power based on a user input of setting the automatic mode.

Also, to increase or decrease suction power, the cleaner 1000 may control the suction motor at a reference speed corresponding to an increase or decrease of suction power. For example, while the cleaner 1000 increases suction power, the cleaner 1000 may increase an output of the suction motor at a gradual rate to thereby prevent overshoot and noise of an output of the suction motor, and while the cleaner 1000 decreases suction power, the cleaner 1000 may decrease the suction power as quickly as possible to prevent adsorption, thereby increasing usability.

Also, the cleaner 1000 may change suction power based on a pattern of suction pressure input by a user's motion. For example, according to reception of a user input of repeatedly performing an operation of lifting and putting down the cleaner head during cleaning, the cleaner 1000 may determine a pattern of suction pressure as a preset pattern, and change suction power to suction power corresponding to the preset pattern. Accordingly, the user may control the cleaner 1000 only by moving the cleaner 1000 while holding the cleaner 1000, without operating any button.

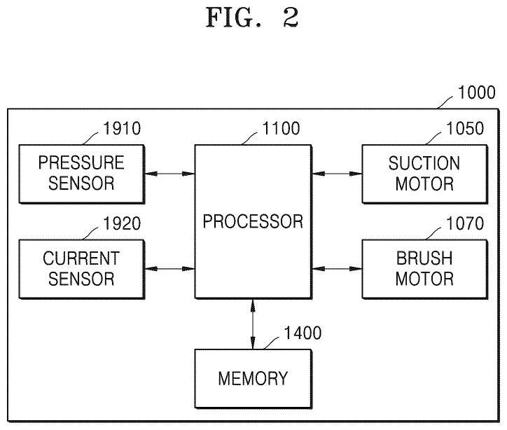

FIG. 2 shows a block diagram of a cleaner according to an embodiment of the disclosure.

Referring to FIG. 2, the cleaner 1000 may include a processor 1100, a memory 1400, a pressure sensor 1910, a current sensor 1820, a suction motor 1050, and a brush motor 1070.

The processor 1100 may control, generally, overall operations of the cleaner 1000. The processor 1100 may execute programs stored in the memory 1400 to control the suction motor 1050, the brush motor 1070, the pressure sensor 1910, and the current sensor 1920.

The memory 1400 may store a program for processing and control by the processor 1100. The processor 1100 may execute software modules stored in the memory 1400 to control the suction motor 1050, the brush motor 1070, the pressure sensor 1910, and the current sensor 1920.

The suction motor (or vacuum motor) 1050 may suck air into a suction port (not shown) of a cleaner head 1950 by rotating a fan (not shown) connected to the suction motor 1050. The suction motor 1050 may include a direct current (DC) suction motor, a dry-type suction motor, and a wet-type suction motor, although not limited thereto.

The brush motor 1070 may rotate a brush 1055. The brush 1955 may be a bristle brush provided with a plurality of bristles or a fur brush provided with fur, although not limited thereto. According to an embodiment, the brush 1955 may have a cylindrical shape, and rotate about a shaft passing through centers of both planes of the cylindrical shape. The brush 1955 may rotate about the shaft by a driving force transferred from a brush motor 1070. While the brush 1955 rotates, the brush 1955 may sweep away dust or foreign materials existing on a floor and move the dust or foreign materials into the suction port (not shown) of the cleaner head 1950.

The current sensor 1920 may detect a current value transferred to the brush motor 1970. When the cleaner head 1950 is placed on a floor made of a smooth material, an output of the brush motor 1070, required to rotate the brush 1955 at a preset speed, may be low. On the contrary, when the cleaner head 1950 is placed on a floor made of fabric such as a carpet, an output of the brush motor 1070, required to rotate the brush 1955 at the same speed, may increase due to friction between the brush 1955 and the carpet, and accordingly, a current value that is transferred to the brush motor 1070 may increase.

The pressure sensor 1910 may detect pressure of air. The pressure sensor 1910 may detect pressure of air sucked into a pipe 1940. The pressure of air detected by the pressure sensor 1910 may be negative pressures. Also, as an output of the suction motor 1050 increases (that is, as current applied to the suction motor 1050 increases, suction pressure may also increase. Also, as the suction port (not shown) of the cleaner head 1050 is adsorbed on a mat, suction pressure may increase.

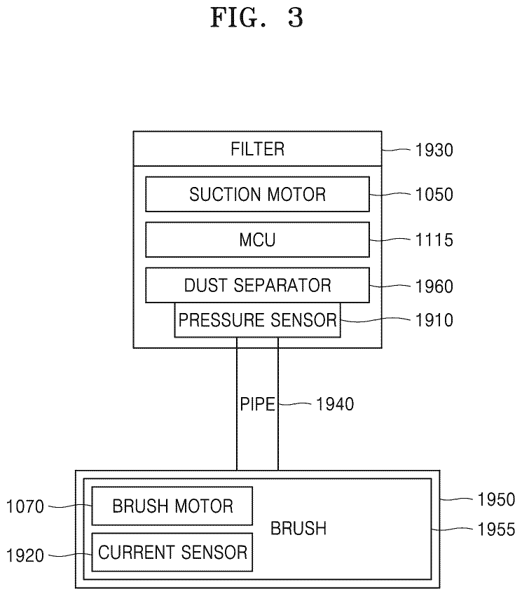

FIG. 3 shows a device diagram of a cleaner according to an embodiment of the disclosure.

Referring to FIG. 3, the cleaner 1000 may include a filter 1930, the suction motor 1050, a micro controller unit (MCU) 1115, a dust separator 1960, the pressure sensor 1910, the pipe 1940, the cleaner head 1950, the brush 1955, the current sensor 1920, and the brush motor 1070.

The suction motor 1050 has been described with reference to FIG. 2.

The cleaner head 1950 may be connected to an end of the pipe 1940 and provided with the suction port (not shown) at a side that contacts a floor. The cleaner head 1950 may be detachably coupled to the pipe 1940. Air sucked into the cleaner head 1950 through the suction port of the cleaner head 1950 may enter the dust separator 1960 via the pipe 1940. Dust in the sucked air may be filtered in the dust separator 1960, relatively clean air may pass through the filter 1930, and the air passed through the filter 1930 may be discharged to outside of the cleaner 1000 through an air blower (not shown).

The cleaner head 1950 may include the brush 1955, the brush motor 1070, and the current sensor 1920.

The brush motor 1070 has been described with reference to FIG. 2.

Also, the brush 1955 may be replaced according to a user's need. The brush 1955 may be detachably coupled to the cleaner head 1950.

The current sensor 1920 and the pressure sensor 1910 have been described with reference to FIG. 2.

The MCU 1115 may include the processor 1100. The MCU 1115 may control components of the cleaner 1000. For example, the MCU 1115 may control the suction motor 1050 to change suction power. Also, the MCU 1115 may control the brush motor 1070 to change a rotation speed of the brush 1955. Also, the MCU 1115 may control the pressure sensor 1910 to detect pressure of air sucked into the pipe 1940. Also, the MCU 1115 may control the current sensor 1920 to detect a current value applied to the brush motor 1070.

Also, while a voltage value applied to the brush motor 1070 is constant, the MCU 1115 may determine output power that is transferred to the brush motor 1070 based on a current value detected by the current sensor 1920 and the voltage value. The MCU 1115 may detect a rotation speed of the brush 1955 and determine output power that is transferred to the brush motor 107 to rotate the brush 1955 at a target speed. While a voltage value applied to the brush motor 1070 is constant, the MCU 1115 may adjust a current value to adjust a rotation speed of the brush 1955. Accordingly, the MCU 1115 may detect a rotation speed of the brush 1955 and adjust a current value that is transferred to the brush motor 1070 to rotate the brush 1955 at a target speed. Also, the MCU 1115 may detect a current value transferred to the brush motor 1070.

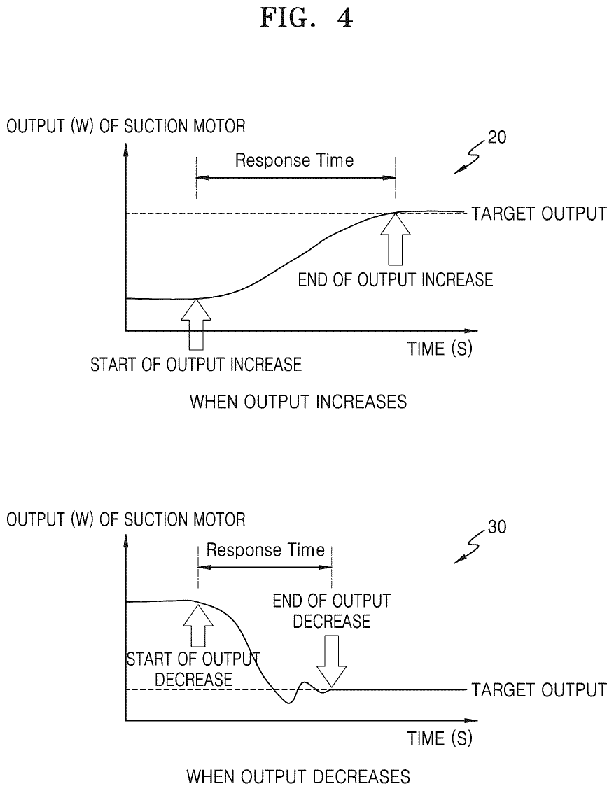

FIG. 4 shows a method of controlling a suction motor to increase or decrease suction power, performed by a cleaner, according to an embodiment of the disclosure.

Referring to FIG. 4, to increase or decrease suction power, the cleaner 1000 may control the suction motor 1050 at a speed corresponding to an increase or decrease of suction power.

A first graph 20 is a graph showing a method of controlling the suction motor 1050 to increase an output of the suction motor 1050. To increase suction power, the cleaner 1000 may set a target output of the suction motor 1050 corresponding to target suction power. As shown in the first graph 20, when the cleaner 1000 increases an output of the suction motor 1050, the cleaner 1000 may determine a current value that is applied to the suction motor 1050 such that an output of the suction motor 1050 increases to a target output at a preset increase speed, and apply current to the suction motor 1050 based on the determined current value. The cleaner 1000 may determine a current value over time to increase the current value at the preset increase speed. The increase speed means an increase value of a suction motor output w over time. The preset increase speed may be a highest speed within a range where overshoot of an output of the suction motor 1050 does not occur.

According to an embodiment of the disclosure, by preventing overshoot of an output of the suction motor 1050, excessive power consumption of the suction motor 1050 may be prevented. Also, according to an embodiment of the disclosure, deterioration of reliability of the suction motor 1050 due to an excessive increase of a number of revolutions of the suction motor 1050 may be prevented. Also, according to an embodiment of the disclosure, excessive noise due to an increase of a number of revolutions of the suction motor 1050 may be prevented.

A second graph 30 is a graph showing a method of controlling the suction motor 1050 to decrease an output of the suction motor 1050. When the cleaner 1000 decreases suction power, the cleaner 1000 may set a target output of the suction motor 1050 corresponding to target suction power. As shown in the second graph 30, when the cleaner 1000 decreases an output of the suction motor 1050, the cleaner 1000 may determine a current value that is applied to the suction motor 1050 such that an output of the suction motor 1050 reaches a target output as quickly as possible, and apply current to the suction motor 1050 based on the determined current value. The cleaner 1000 may determine a current value over time to decrease the current value at a preset decrease speed.

According to an embodiment of the disclosure, the cleaner 1000 may decrease an output of the suction motor 1050 to the target output as quickly as possible by applying no current to the suction motor 1050 for a preset short time. The cleaner 1000 may block current that is applied to the suction motor 1050, for the preset short time. Even when an output of the suction motor 1050 is rapidly decreased, the output of the suction motor 1050 may fluctuate greatly. However, upon the decrease, the reliability of the suction motor 1050 or the power consumption of the suction motor 1050 is not a problem. Accordingly, by decreasing the output of the suction motor 1050 as quickly as possible, it may be possible to prevent adsorption and lower consumption power.

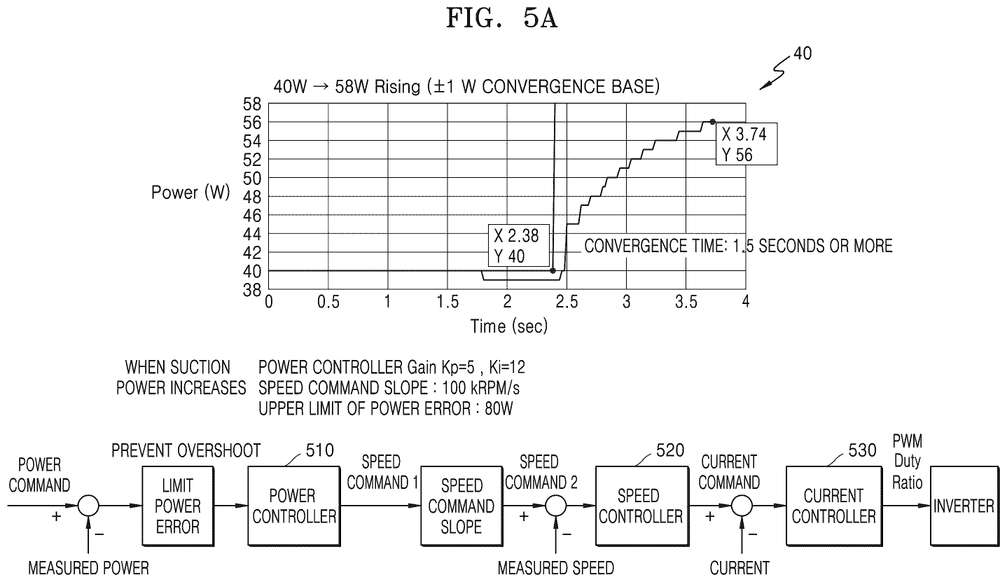

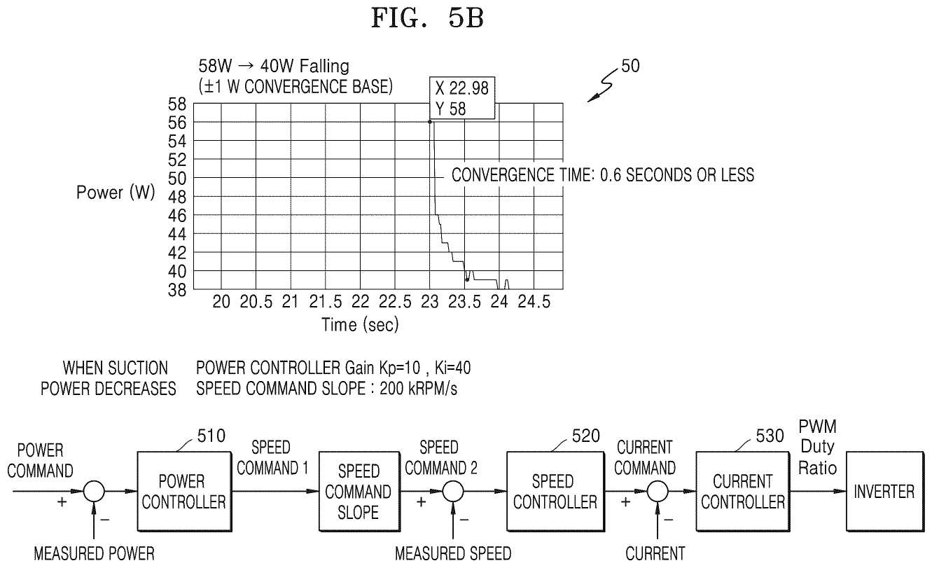

FIGS. 5A and 5B show a method of controlling a suction motor to increase suction power, performed by a cleaner, according to various embodiments of the disclosure.

A power controller 510, a speed controller 520, and a current controller 530 of FIGS. 5A and 5B may correspond to the processor 1100 of FIG. 2 or the MCU 1115 of FIG. 3.

Referring to FIG. 5A, the cleaner 1000 may control, when increasing suction power, current that is applied to the suction motor 1050 such that overshoot of an output of the suction motor 1050 does not occur.

For example, as shown in FIG. 5A, when the cleaner 1000 increases an output of the suction motor 1050 from 40 W to 58 W, an input value that is input to the power controller 510 may be a value obtained by subtracting a measurement command of 40 W from a power command of 58 W. The value obtained by subtracting the measurement command from the power command may be limited to 80 W which is an upper limit value of power error in order to prevent overshoot of an output of the suction motor 1050.

The power controller 510 may be a PI controller, a proportional gain Kp of the power controller 510 may be 5, and an integral gain Ki of the power controller may be 12.

The power controller 510 may calculate a speed command 1, which is a rotation speed of the suction motor 1050 required to output a target output value of 58 W, based on the input value. The speed command 1 calculated by the power controller 510 may be adjusted with a speed command slope of 100 kPRM/s or less. A value obtained by subtracting a current speed of the suction motor 1050 from a speed command 2 which is a value obtained by adjusting the speed command 1 by the speed command slope may be input as an input value of the speed controller 520. The speed controller 520 may output a current command required for the target output value of 58 W based on the input value. A value obtained by subtracting a current value currently applied to the suction motor 1050 from the current command output from the speed controller 520 may be input as an input value of the current controller 530. The current controller 530 may determine a current waveform that is applied to the suction motor 1050 in consideration of the received input value and a Pulse Width Modulation (PWM) duty ratio, and apply the determined current waveform to the suction motor 1050.

Accordingly, as shown in an output increase graph 40 of FIG. 5A, the cleaner 1000 may set an increase consumption time taken for the cleaner 1000 to increase an output of the suction motor 1050 from 40 W to 58 W, based on a preset gain of the power controller 510, the speed command slope, and the upper limit value of power error. For example, in the output increase graph 40 of FIG. 5A, the increase consumption time is set to 1.5 seconds. The cleaner 1000 may control the suction motor 1050 such that 1.5 seconds or more is consumed until an output of the suction motor 1050 increases from 40 W to 58 W.

Referring to FIG. 5B, the cleaner 1000 may control, when decreasing suction power, current that is applied to the suction motor 1050 such that an output of the suction motor 1050 decreases as quickly as possible.

For example, as shown in FIG. 5B, when the cleaner 1000 decreases an output of the suction motor 1050 from 58 W to 40 W, an input value that is input to the power controller 510 may be a value obtained by subtracting a measurement command of 58 W from a power command of 40 W.

The power controller may be a PI controller. When an output of the suction motor 1050 decreases, a proportional gain Kp of the power controller may be 5, and an integral gain Ki of the power controller may be 12.

The power controller may calculate a speed command 1 which is a rotation speed of the suction motor 1050 required to output a target output value of 40 W, based on the input value. The speed command 1 calculated by the power controller may be adjusted with a speed command slope of 200 kPRM/s or more. A value obtained by subtracting a current speed of the suction motor 1050 from a speed command 2 which is a value obtained by adjusting the speed command 1 by the speed command slope may be input as an input value of the speed controller 520. The speed controller 520 may output a current command required for the target output value of 40 W based on the input value. A value obtained by subtracting a current value currently applied to the suction motor 1050 from the current command output from the speed controller 520 may be input as an input value of the current controller 530. The current controller 530 may determine a current waveform that is applied to the suction motor 1050 in consideration of the received input value and a PWM duty rate, and apply the determined current waveform to the suction motor 1050. Accordingly, as shown in an output decrease graph 50 of FIG. 5B, the cleaner 1000 may set a decrease consumption time taken for the cleaner 1000 to decrease an output of the suction motor 1050 from 58 W to 40 W, based on a preset gain of the power controller 510 and the speed command slope. For example, in the output decrease graph 50 of FIG. 5B, the decrease consumption time is set to 0.6 seconds. The cleaner 1000 may control the suction motor 1050 such that 0.6 seconds or less is consumed until an output of the suction motor 1050 decreases from 58 W to 40 W.

By setting a gain of the power controller and a speed command slope limit when an output of the suction motor 1050 increases differently from those when an output of the suction motor 1050 decreases, the suction motor 1050 may be controlled such that an output decrease speed is higher than an output increase speed. Also, by setting a power error limit for preventing overshoot, overshoot of an output of the suction motor 1050 may be prevented.

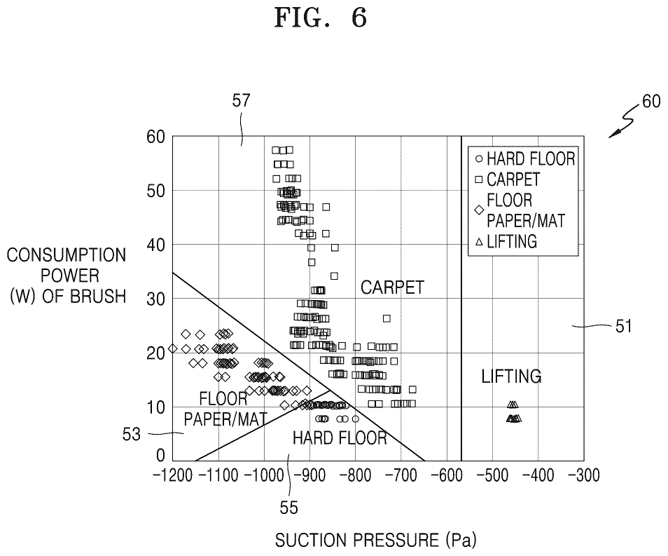

FIG. 6 shows a method of identifying a type of a floor based on suction pressure and consumption power of a brush motor, performed by a cleaner, according to an embodiment of the disclosure.

Referring to FIG. 6, the cleaner 1000 may identify a type of a floor based on suction pressure and consumption power of the brush motor 1070.

The cleaner 1000 may control the pressure sensor 1910 to detect pressure of sucked air. Also, the cleaner 1000 may control the current sensor 1920 to calculate consumption power of the brush motor 1070.

With regard to consumption power of the brush motor 1070 with reference to a graph 60 of FIG. 6, power consumption of the brush motor 1070 when the cleaner 1000 is placed on a hard floor and when the cleaner 1000 is lifted up (lifting) is lowest. It is shown that, when the cleaner 1000 is placed on a floor paper or mat, consumption power of the brush motor 1070 increases, and when the cleaner 1000 is placed on a carpet, consumption power of the brush motor 1070 is greatest.

With regard to suction pressure with reference to the graph 60 of FIG. 6, it is shown that suction pressure is lowest when the cleaner 1000 is lifted up, suction pressure is highest when the cleaner 1000 is placed on a floor paper or mat, and suction pressure when the cleaner 1000 is placed on a carpet is similar to or a little lower than suction pressure when the cleaner 1000 is placed on a hard floor.

Also, referring to the graph 60 of FIG. 6, it is shown that suction pressure when the cleaner 1000 is lifted up is significantly lower than those when the cleaner 1000 is placed on different types of floors.

Accordingly, based on a relationship of FIG. 6 between types of floors, suction pressure, and consumption power of the brush motor 1070, the cleaner 1000 may identify a type of a floor based on suction pressure and consumption power of the motor 1070.

For example, when a detected magnitude of suction pressure is 600 Pa or less and consumption power of the brush motor 1070 is within a range of 5 W to 10 W, the cleaner 1000 may determine a type of a floor as lifting (that is, the suction port of the cleaner head is lifted off the floor). Also, for example, based on a determination that suction pressure of the cleaner 100 and consumption power of the brush motor 1070 are located in a first area 51 of the graph 60, the cleaner 1000 may determine a type of a floor as lifting.

Also, for example, when detected suction pressure is within a range of 950 Pa to 1050 Pa and consumption power of the brush motor 1070 is within a range of 10 W to 20 W, the cleaner 100 may identify a type of a floor as a floor paper or mat. Also, for example, based on a determination that suction pressure of the cleaner 100 and consumption power of the brush motor 1070 are located in a second area 53 of the graph 60, the cleaner 1000 may determine a type of a floor as a floor paper or mat. Also, when detected suction pressure is 1050 Pa or more, the cleaner 1000 may determine that the cleaner head has been adsorbed on a floor paper or mat.

Also, for example, when detected suction pressure is within a range of 800 Pa to 900 Pa and consumption power of the brush motor 1070 is within a range of 5 W to 12 W, the cleaner 1000 may identify a floor as a hard floor. Also, for example, based on a determination that suction pressure of the cleaner 1000 and consumption power of the brush motor 1070 are located in a third area 55 of the graph 60, the cleaner 1000 may identify a type of a floor as a hard floor.

Also, for example, when detected suction pressure is within a range of 700 Pa to 1000 Pa and consumption power of the brush motor 1070 is 15 W, the cleaner 1000 may identify a type of a floor as a carpet. Also, for example, based on a determination that suction pressure of the cleaner 1000 and consumption power of the brush motor 1070 are located in a fourth area 57 of the graph 60, the cleaner 1000 may identify a type of a floor as a carpet.

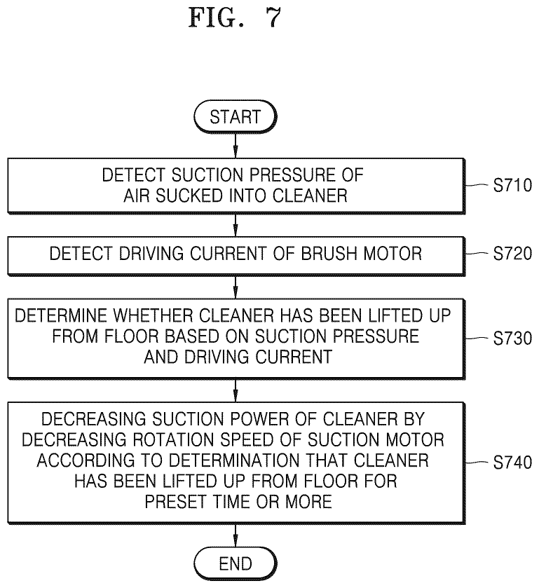

FIG. 7 is a flowchart illustrating a method of adjusting suction power according to a type of a floor, performed by a cleaner, according to an embodiment of the disclosure.

Referring to FIG. 7, in operation S710, the cleaner 1000 may detect suction pressure of air sucked into the cleaner 1000.

The cleaner 1000 may detect suction pressure of air sucked into the pipe 1940 of the cleaner 1000 through the pressure sensor 1910.

In operation S720, the cleaner 1000 may detect driving current of the brush motor 1070.

The cleaner 1000 may detect driving current applied to the brush motor 1070 through the current sensor 1920.

In operation S730, the cleaner 1000 may determine whether the cleaner 1000 has been lifted up from the floor based on the suction pressure and driving current.

The cleaner 1000 may identify a type of a floor on which the cleaner 1000 is placed, based on the suction pressure and driving current. According to a determination that the cleaner 1000 has been lifted up from the floor, the cleaner 1000 may identify the type of the floor as ‘lifting’.

In operation S740, according to a determination that the cleaner 1000 has been lifted up from the floor for a reference time or more, the cleaner 1000 may decrease suction power of the cleaner 1000 by decreasing a rotation speed of the suction motor 1050.

The cleaner 1000 may change suction power of the cleaner 1000 to a strength of suction power corresponding to the identified type of the floor. According to the type of the floor being identified as ‘lifting’, the cleaner 1000 may change suction power of the cleaner 1000 to a strength of suction power corresponding to ‘lifting’.

According to an embodiment, the cleaner 1000 may increase or decrease an output of the suction motor 1050 by applying current to the suction motor 1050 based on the strength of suction power corresponding to the identified type of the floor. In this case, the cleaner 1000 may control the suction motor 1050 such that a speed at which an output decreases is higher than a speed at which an output increases.

Also, according to an embodiment, the cleaner 1000 may display a guide UI for guiding a change of suction power of the cleaner 1000 to the strength of suction power corresponding to the type of the floor.

For example, when the identified type of the floor has changed, the cleaner 1000 may display a guide UI for guiding a change of suction power of the cleaner 1000 to a strength of suction power corresponding to the type of the floor. Only upon reception of a user input to the guide UI for guiding a change of suction power of the cleaner 1000, the cleaner 1000 may change the suction power of the cleaner 1000 to the strength of the suction power corresponding to the type of the floor.

Also, according to an embodiment, the cleaner 1000 may display the identified type of the floor and the strength of the suction power.

Also, according to an embodiment, based on reception of a user input of changing suction power a reference number of times or more within a reference time, the cleaner 1000 may display a guide UI for guiding setting of a suction power automatic mode.

Also, according to an embodiment, the cleaner 1000 may recognize a user's motion based on a pattern of suction pressure. A pattern of suction pressure according to a user's preset motion may have been stored in advance in the cleaner 1000. The user's preset motion may be, for example, an operation that repeatedly performs lifting the cleaner and then putting the cleaner down on the floor within a reference time.

For example, the cleaner 1000 may detect the pattern of suction pressure through the pressure sensor 1910. Also, according to a determination that the pattern of suction pressure represents a preset pattern, the cleaner 1000 may change a strength of suction power of the cleaner 1000 to a strength of suction power corresponding to the preset pattern, and maintain the changed suction power for a preset time.

For example, according to reception of a user input of repeatedly performing an operation of lifting the cleaner 1000 such that the suction port of the cleaner head is lifted off the floor and then putting the cleaner 1000 down on the floor, the cleaner 1000 may determine that a pattern of suction pressure represents the preset pattern, change suction power of the cleaner 1000 to a highest strength of suction power among a plurality of strengths of suction power provided by the cleaner 1000, and maintain the changed suction power for a preset time.

Also, according to an embodiment, based on a determination that the cleaner 1000 has been lifted up from the floor for a reference time or more, the cleaner 1000 may decrease suction power of the cleaner 1000 and an output of the brush motor 1070.

The cleaner 1000 may perform one among the above-described embodiments or two or more among the above-described embodiments together.

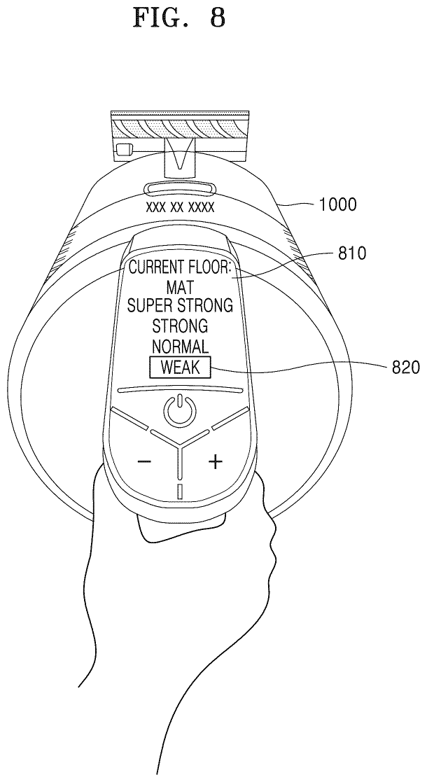

FIG. 8 shows a method of displaying an identified type of a floor, performed by a cleaner, according to an embodiment of the disclosure.

Referring to FIG. 8, according to identifying of a type of a floor on which the head of the cleaner 1000 is placed, the cleaner 1000 may display the identified type of the floor. Also, a strength of suction power changed according to the identified type of the floor may be displayed.

For example, the cleaner 1000, which provides “super strong,” “strong,” “normal,” and “weak” as selection options for strengths of suction power, may be placed on a mat while cleaning at a strength of “strong.” According to adsorption of the suction port of the cleaner 1000 to the mat, suction pressure may exceed a reference pressure value. When suction pressure exceeds the reference pressure value, the cleaner 1000 may identify a type of a floor as a mat, and determine a change of a strength of suction power to “weak” which is a strength of suction corresponding to a mat. The cleaner 1000 may display information notifying a change of a strength of suction power. For example, the cleaner 1000 may flash an indicator corresponding to the changed strength of suction power for a preset time. Also, for example, the cleaner 1000 may display a message notifying that suction power has changed. The cleaner 1000 may change a strength of suction power to “weak” by applying a current value corresponding to “weak” to the suction motor 1050.

By changing the strength of suction power, the cleaner 1000 may output an alarm sound notifying that suction power has changed. Also, the cleaner 1000 may display an icon or message 810 representing that the identified type of the floor is a mat. Also, the cleaner 1000 may display a strength 820 of suction power corresponding to the identified type of the floor.

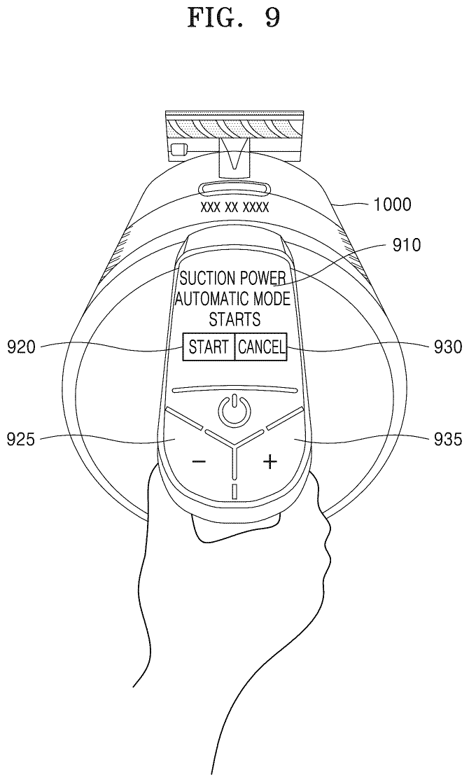

FIG. 9 shows a method of providing a guide UI for setting a suction power automatic mode, performed by a cleaner, according to an embodiment of the disclosure.

Referring to FIG. 9, the cleaner 1000 may display a guide UI for setting a suction power automatic mode.

The cleaner 1000 may display the guide UI for setting the suction power automatic mode when a frequency of changing a type of a floor increases. For example, when cleaning is performed alternately between a mat and a hard floor, a type of a floor identified by the cleaner 1000 may frequently change from the mat to the hard floor and from the hard floor to the mat. When the type of the floor changes a reference number of times or more within a reference time, the cleaner 1000 may display the guide UI for setting the suction power automatic mode.

Also, when a frequency of a user input of changing suction power exceeds a threshold frequency, the cleaner 1000 may display the guide UI for setting the suction power automatic mode. For example, according to reception of a user input of changing suction power the reference number of times (for example, twice) or more within the reference time (for example, 2 minutes), the cleaner 1000 may display the guide UI for setting the suction power automatic mode.

The guide UI for setting the suction power automatic mode may include a start button graphical user interface (GUI) 920 and a cancel button GUI 930, together with a message 910 representing a start of the suction power automatic mode. According to reception of a user input of pressing a button 925 corresponding to the start button GUI 920, the cleaner 1000 may start the suction power automatic mode. According to a start of the suction power automatic mode, the cleaner 1000 may identify a type of a floor based on suction pressure and brush consumption power, and change suction power based on the identified type of the floor.

Also, according to reception of a user input of pressing a button 935 corresponding to the cancel button GUI 930, the cleaner 1000 may delete the guide UI for setting the suction power automatic mode. Also, when no user input to the guide UI is received for a preset time after the guide UI for setting the suction power automatic mode is displayed, the cleaner 1000 may delete the guide UI for setting the suction power automatic mode.

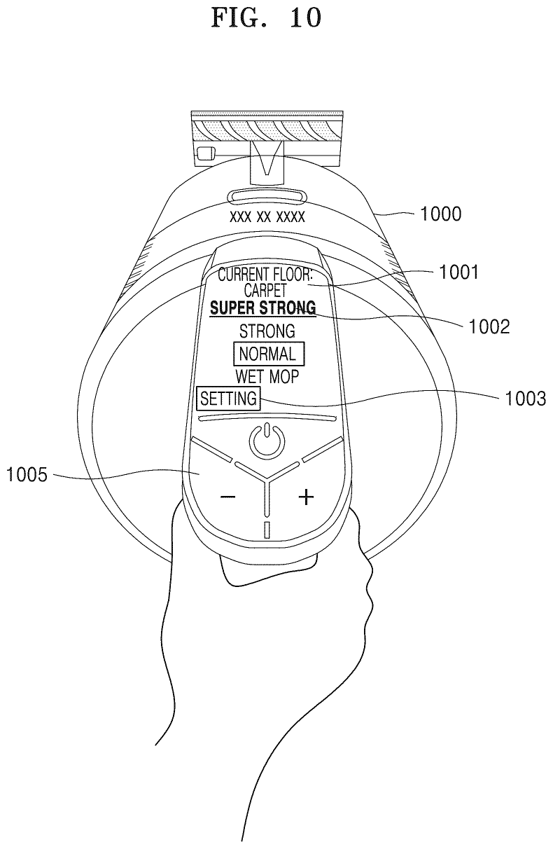

FIG. 10 shows a method of displaying a guide UI for guiding a change of suction power of a cleaner according to a type of a floor, performed by a cleaner, according to an embodiment of the disclosure.

Referring to FIG. 10, when an identified type of a floor has changed, the cleaner 1000 may display a guide UI for guiding a change of suction power of the cleaner 1000.

For example, while the cleaner 1000 moves from a hard floor to a carpet, the cleaner 1000 may identify a type of a floor as a hard floor and then identify a type of a floor as a carpet. According to a determination that the identified type of the floor has changed, the cleaner 1000 may determine whether a currently set strength of suction power is identical to a strength of suction power corresponding to the identified type of the floor. According to a determination that the currently set strength of suction power is not identical to the strength of the floor corresponding to the identified type of the floor, the cleaner 1000 may display a guide UI for recommending a change of the strength of suction power of the cleaner 1000 to the strength of suction power corresponding to the identified type of the floor. Referring to FIG. 10, while the cleaner 1000 is driven at a strength of suction power of “norma,”, the cleaner 1000 may display a guide UI for recommending a change of a strength of suction power to a strength of suction power of “super strong” corresponding to a carpet as an identified type of a floor.

The guide UI for guiding the change of suction power may include an identified type 1001 of a floor and a strength 1002 of suction power corresponding to the identified type of the floor. Also, the guide UI for guiding the change of suction power may include a GUI setting button 1003 for changing suction power of the cleaner 1000 to a strength of suction power corresponding to the identified type of the floor. According to reception of a user input of pressing the button 1005 corresponding to the GUI setting button 1003, the cleaner 1000 may change suction power of the cleaner 1000 to the strength of suction power corresponding to the identified type of the floor.

Also, when no user input to the guide UI for guiding a change of suction power is received for a preset time after the guide UI is displayed, the cleaner 1000 may delete the guide UI for setting the suction power automatic mode without changing the strength of the suction power.

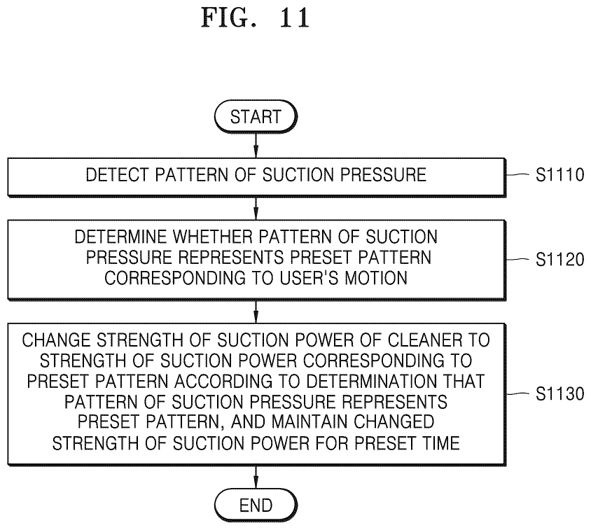

FIG. 11 is a flowchart illustrating a method of changing a strength of suction power based on a pattern of suction pressure according to a user operation, performed by a cleaner, according to an embodiment of the disclosure.

Referring to FIG. 11, in operation S1110, the cleaner 1000 may detect a pattern of suction pressure.

The cleaner 1000 may control the pressure sensor 1910 to detect a suction pressure value over time, and determine the suction pressure value over time as a pattern of suction pressure.

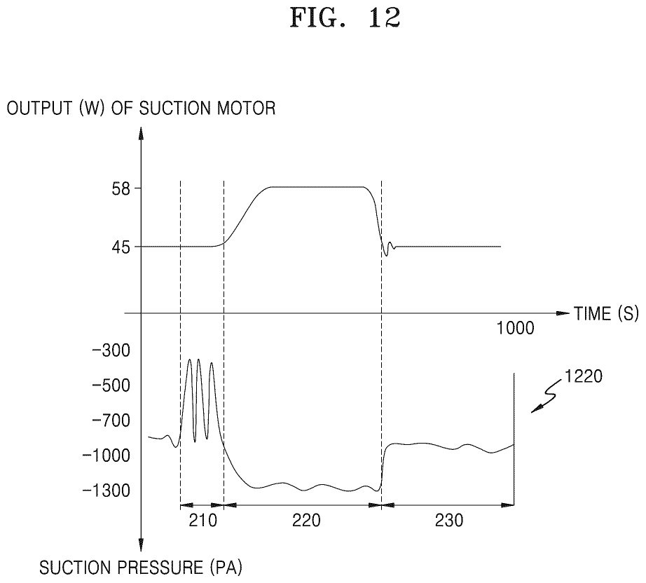

For example, when a user repeatedly performs an operation of lifting the cleaner 1000 such that the suction port of the cleaner head is lifted off a floor and then putting the cleaner 1000 down, suction pressure of the cleaner 1000 may repeatedly decrease and increase greatly within a short time as in a suction pressure graph 1220 of FIG. 12. The cleaner 1000 may have stored, as a preset pattern, a pattern in which a decrease to preset suction pressure (for example, suction pressure corresponding to lifting) and then an increase to previous suction pressure are repeated a preset number of times or more for a preset time period.

In operation S1120, the cleaner 1000 may determine whether a pattern of suction pressure represents the preset pattern corresponding to a user's motion.

The cleaner 1000 may determine whether the determined pattern of suction pressure represents the preset pattern corresponding to the user's motion.

In operation S1130, according to a determination that the pattern of suction pressure represents the preset pattern, the cleaner 1000 may change a strength of suction power to a strength of suction power corresponding to the preset pattern, and maintain the changed strength of suction power for a preset time.

A plurality of preset patterns may be provided, and different strengths of suction power may have been stored in advance to correspond to the respective preset patterns.

For example, suction power of the cleaner 1000 may increase to a second highest level in response to a user's motion of performing, twice, an operation of lifting the cleaner head and then putting the cleaner head down. Also, for example, suction power of the cleaner 1000 may increase to a highest level in response to a user's motion of performing, three times, an operation of lifting the cleaner head and then putting the cleaner head down.

The cleaner 1000 may maintain the changed strength of suction power. For example, the cleaner 1000 may maintain the changed strength of suction power until a next user input is received after the suction power has changed. Also, the cleaner 1000 may maintain the strength of suction power only for a preset time, and return to a strength of suction power before the strength of suction power has changed, according to elapse of the preset time.

The preset time may be 5 seconds or 10 seconds, although not limited thereto.

Accordingly, the user may control the cleaner 1000 only by moving the cleaner 1000 while holding the cleaner 1000, without operating any button.

FIG. 12 shows a method of temporarily changing a strength of suction power based on a pattern of suction pressure according to a user's operation, performed by a cleaner, according to an embodiment of the disclosure.

Referring to FIG. 12, the cleaner 1000 may recognize a user's motion based on a pattern of suction power. When a user repeatedly performs an operation of lifting the cleaner 1000 such that the suction port of the cleaner head is lifted off a floor and then putting the cleaner 1000 down, the cleaner 1000 may temporarily increase suction power of the cleaner 1000 to preset suction power.

For example, while the cleaner 1000 drives the suction motor 1050 with suction power of a “normal” level, the cleaner 1000 may receive a user input of performing, three times, an operation of lifting the cleaner head and then putting the cleaner head down. In this case, as in a first section 210 of the suction pressure graph 1220 of FIG. 12, suction pressure of the cleaner 1000 may represent a pattern in which a section where suction pressure decreases to suction pressure corresponding to lifting and then increases to previous suction pressure appears three times.

The cleaner 1000 may determine that the pattern of the first section 210 is identical to a preset pattern. According to detection of the preset pattern in the first section 210, the cleaner 1000 may increase suction power of the cleaner 1000 to a “super strong” level which is a strength of suction power corresponding to the preset pattern. Also, referring to a second time section 220 of FIG. 12, the cleaner 1000 may maintain a strength of suction power at “super strong” for a preset time (the second time section 220 of FIG. 12). Also, referring to a third time section 230 of FIG. 12, the cleaner 1000 may decrease suction power of the cleaner 1000 to a “normal” level after the preset time elapses.

Accordingly, when a user temporarily needs strong suction power while cleaning a floor, the user may temporarily use strong suction power only by moving the cleaner 1000 without operating any button.

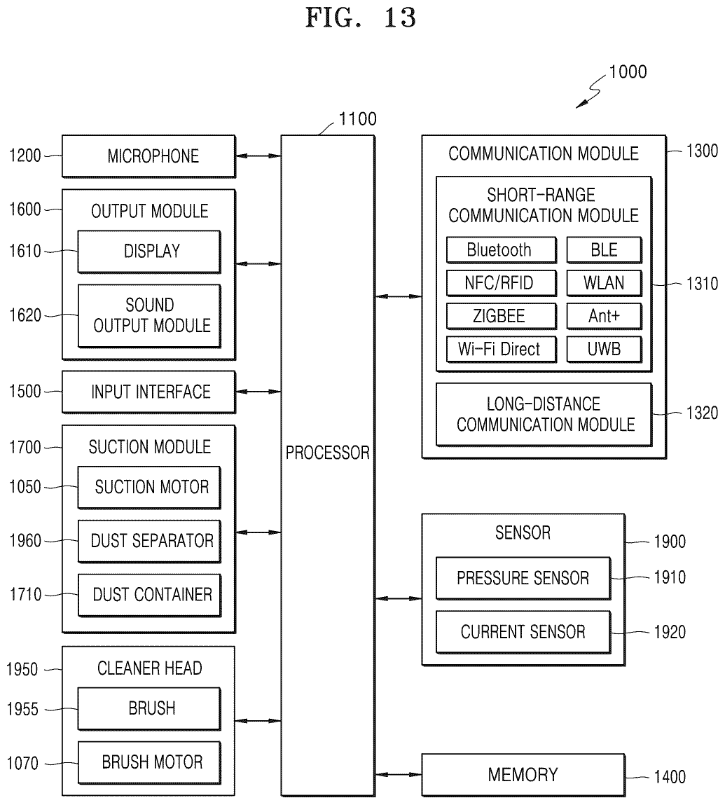

FIG. 13 shows a block diagram of a cleaner according to an embodiment of the disclosure.

Referring to FIG. 13, the cleaner 1000 may include a microphone 1200, a communication module 1300, a memory 1400, an input interface 1500, an output module 1600, a suction module 1700, the cleaner head 1950, a sensor 1900, the suction motor 1050, the brush motor 1070, and the processor 1100. The same components as those shown in FIG. 2 are assigned the same reference numerals.

All of the shown components are not essential components of the cleaner 1000. The cleaner 1000 may be configured with more components than those shown in FIG. 13 or with less components than those shown in FIG. 13.

The output module 1600 may include a sound output module 1620 and a display 1610.

The sound output module 1620 may output a sound signal to outside of the cleaner 1000. The sound output module 1620 may include, for example, a speaker or a receiver. The speaker may be used for general purposes, such as playing multimedia or playing recordings.

The display 1610 may output image data image-processed by an image processor (not shown) through a display panel (not shown), according to a control by the processor 1100. The display panel (not shown) may include at least one among a liquid crystal display, a thin film transistor-liquid crystal display, an organic light-emitting diode, a flexible display, a three-Dimensional (3D) display, or an electrophoretic display.

The input interface 1500 may receive a user input for controlling the cleaner 1000. The input interface 1500 may receive the user input and transfer the user input to the processor 1100.

The input interface 1500 may include a user input electronic device including a touch panel for detecting a user's touch, a button for receiving a user's push operation, a wheel for receiving a user's rotation operation, a key board, and a dome switch, although not limited thereto.

Also, the input interface 1500 may include a voice recognition device for voice recognition. For example, the voice recognition device may be the microphone 1200, and the voice recognition device may receive a user's voice command or a user's voice request. Accordingly, the processor 1100 may control an operation corresponding to a voice command or a voice request to be performed.

The memory 1400 may store various information, data, an instruction, a program, etc. required for operations of the cleaner 1000. The memory 1400 may include at least one of a volatile memory or a non-volatile memory or a combination thereof. The memory 1400 may include at least one type of storage medium among a flash memory type, a hard disk type, a multimedia card micro type, a card type memory (e.g., secure digital (SD) or extreme digital (XD) memory), random access memory (RAM), static random access memory (SRAM), read only memory (ROM), electrically erasable programmable read-only memory (EEPROM), programmable read-only memory (PROM), a magnetic memory, a magnetic disk, or an optical disk. Also, the cleaner 1000 may operate a web storage or a cloud server that performs a storage function on the Internet.

The communication module 1300 may transmit/receive information according to a protocol to/from an external device or an external server under control by the processor 1100. The communication module 1300 may include at least one communication module and at least one port for transmitting/receiving data to/from an external device (not shown).

Also, the communication module 1300 may communicate with an external device through at least one wired or wireless network. The communication module 1300 may include at least one of a short-range communication module 1310 or a long-distance communication module 1320 or a combination thereof. The communication module 1300 may include at least one antenna for communicating with another device wirelessly.

The short-range communication module 1310 may include at least one communication module (not shown) that performs communication according to a communication standard, such as bluetooth, wireless fidelity (Wi-Fi), bluetooth low energy (BLE), near-field communication (NFC)/radio frequency identification (RFID), Wi-Fi direct, ultra wideband (UWB), or ZIGBEE. Also, the long-distance communication module 1320 may include a communication module that performs communication through a network for Internet communication. Also, the long-distance communication module 1320 may include a mobile communication module that performs communication according to a communication standard, such as 3^{rd} generation (3G), 4^{th} generation (4G), 5^{th} generation (5G), and/or 6^{th} generation (6G).

Also, the communication module 1300 may include a communication module capable of receiving a control command from a remote controller (not shown) located nearby, for example, an infrared (IR) communication module.

The suction module 1700 may include the suction motor 1050, the dust separator 1960, and a dust container 1710. The suction motor 1050 and the dust separator 1960 have been described with reference to FIG. 3. Dust filtered by the dust separator 1960 may be stored in the dust container 1700.

The cleaner head 1950 may include the brush 1955 and the brush motor 1070.

The sensor 1900 may include various types of sensors.

For example, the sensor 1900 may include the pressure sensor 1910 and the current sensor 1920. Also, for example, the sensor 1900 may include a plurality of sensors configured to detect information about an environment around the cleaner 1000. For example, the sensor 1900 may include an ultrasound sensor (not shown), a motion sensor (not shown), etc., although not limited thereto. Functions of the individual sensors are intuitively inferred by one of ordinary skill in the art from their names, and therefore, detailed descriptions thereof will be omitted.

The processor 1100 may control overall operations of the cleaner 1000. The processor 1100 may execute a program stored in the memory 1400 to control components of the cleaner 1000.

According to an embodiment, the processor 1100 may include a separate neural processing unit (NPU) that performs operations of a machine learning model. Also, the processor 1100 may include a central processing unit (CPU), a graphic processing unit (GPU), etc.

The processor 1100 may detect suction pressure of air sucked into the cleaner 1000, through the pressure sensor 1910. The processor 1100 may detect driving current of the brush motor 1070 through the current sensor 1920. The processor 1100 may determine whether the cleaner 1000 has been lifted up from a floor, based on the suction pressure and the driving current.

According to a determination that the cleaner 1000 has been lifted up from the floor for a reference time or more, the processor 1100 may decrease a current value that is applied to the suction motor 1050 to thereby decrease a rotation speed of the suction motor 1050 and, as the rotation speed of the suction motor 1050 decreases, suction power of the cleaner 1000 may decrease.

The processor 1100 may identify a type of a floor on which the cleaner 1000 is placed, based on the suction pressure and the driving current. The processor 1100 may change suction power of the cleaner 1000 to a strength of suction power corresponding to the identified type of the floor.

The processor 1100 may apply current to the suction motor 1050 based on the strength of suction power corresponding to the identified type of the floor, thereby increasing or decreasing an output of the suction motor 1050.

The processor 1100 may control the display 1610 to display the identified type of the floor and the strength of suction power.

The processor 1100 may control the display 1610 to display a guide UI for guiding setting of a suction power automatic mode, based on reception of a user input of changing suction power a reference number of times or more within a reference time.

The processor 1100 may control the display 1610 to display a guide UI for guiding a change of suction power of the cleaner 1000 to a strength of suction power corresponding to a type of a floor.

According to reception of a user input to the guide UI, the processor 1100 may change the suction power of the cleaner 1000 to the strength of the suction power corresponding to the type of the floor.

When the identified type of the floor has changed, the processor 1100 may control the display 1610 to display a guide UI for guiding a change of suction power of the cleaner 1000 to a strength of suction power corresponding to the type of the floor.

The processor 1100 may detect a pattern of suction pressure.

According to a determination that the pattern of suction pressure represents a preset pattern, the processor 1100 may change a strength of suction power of the cleaner 1000 to a strength of suction power corresponding to the preset pattern, and maintain the changed suction power for a preset time.

According to reception of a user input of repeatedly performing an operation of lifting the cleaner 1000 such that the suction port of the cleaner head 1950 is lifted off the floor and then putting the cleaner 1000 down on the floor, the processor 1100 may determine that the pattern of suction power represents the preset pattern. According to a determination that the pattern of suction pressure represents the preset pattern, the processor 1100 may change the suction power of the cleaner 1000 to a highest strength of suction power among a plurality of strengths of suction power provided by the cleaner 1000, and then maintain the changed suction power for a preset time.

According to a determination that the cleaner 1000 has been lifted up from the floor for a reference time or more, the processor 1100 may decrease suction power of the cleaner 1000 and an output of the brush motor 1070.

A machine-readable storage medium may be provided in the form of a non-transitory storage medium. Herein, ‘non-transitory storage medium’ means that the storage medium does not include a signal (e.g., an electromagnetic wave) and is tangible, without meaning that data is semi-permanently or temporarily stored in the storage media. For example, a ‘non-transitory storage medium’ may include a buffer in which data is temporarily stored.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloadable or uploadable) online via an application store or between two user devices (e.g., smart phones) directly. When distributed online, at least part of the computer program product (e.g., a downloadable app) may be temporarily generated or at least temporarily stored in the machine-readable storage medium, such as a memory of the manufacturer's server, a server of the application store, or a relay server.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A cleaner comprising:
a pressure sensor;
a current sensor;
a suction motor;
a brush motor;
memory, comprising one or more storage media, storing instructions; and
one or more processors coupled to the pressure sensor, the current sensor, and the memory,
wherein the instructions, when executed by the one or more processors individually or collectively, cause the cleaner to:
obtain a suction pressure value of air sucked into the cleaner from the pressure sensor,
obtain a driving current value of the brush motor from the current sensor,
determine whether the cleaner has been lifted up from a floor based on the suction pressure value and the driving current value, and
decrease suction power of the cleaner by decreasing a rotation speed of the suction motor according to a determination that the cleaner has been lifted up from the floor for a reference time or more.

2. The cleaner of claim 1, wherein the instructions, when executed by the one or more processors individually or collectively, further cause the cleaner to:
identify a type of a floor on which the cleaner is placed, based on the suction pressure value and the driving current value; and
change the suction power of the cleaner to a strength of suction power corresponding to the identified type of the floor.

3. The cleaner of claim 2,
wherein the instructions, when executed by the one or more processors individually or collectively, further cause the cleaner to:
increase or decrease an output of the suction motor by applying current to the suction motor based on the strength of suction power corresponding to the identified type of the floor, and
wherein an output decrease rate when the output decreases is higher than an output increase rate when the output increases.

4. The cleaner of claim 2, further comprising:
a display,
wherein the instructions, when executed by the one or more processors individually or collectively, further cause the cleaner to:
control the display to display the identified type of the floor and the strength of suction power.

5. The cleaner of claim 2, further comprising:
a display,
wherein the instructions, when executed by the one or more processors individually or collectively, further cause the cleaner to:
control the display to display a guide user interface (UI) for guiding setting of a suction power automatic mode, based on reception of a user input of changing suction power a reference number of times or more within a reference time.

6. The cleaner of claim 2, further comprising:
a display,
wherein the instructions, when executed by the one or more processors individually or collectively, further cause the cleaner to:
control the display to display a guide user interface (UI) for guiding a change of the suction power of the cleaner to the strength of suction power corresponding to the type of the floor, and
change the suction power of the cleaner to the strength of suction power corresponding to the type of the floor, according to reception of a user input to the guide UI.

7. The cleaner of claim 6, wherein the instructions, when executed by the one or more processors individually or collectively, further cause the cleaner to:
display, when the identified type of the floor has changed, the guide UI for guiding a change of the suction power of the cleaner to the strength of suction power corresponding to the type of the floor.

8. The cleaner of claim 1, wherein the instructions, when executed by the one or more processors individually or collectively, further cause the cleaner to:
detect a pattern of the suction pressure value;
change, according to a determination that the pattern of the suction pressure value represents a preset pattern, a strength of suction power of the cleaner to a strength of suction power corresponding to the preset pattern; and
maintain the changed suction power for a preset time.

9. The cleaner of claim 8, wherein the instructions, when executed by the one or more processors individually or collectively, further cause the cleaner to:
according to reception of a user's motion input of repeatedly performing an operation of lifting the cleaner such that a suction port of a cleaner head is lifted up from the floor and then putting the cleaner down on the floor, determine that the pattern of the suction pressure value represents the preset pattern to recognize the user's motion;
change the suction power of the cleaner to a highest strength of suction power among a plurality of strengths of suction power provided by the cleaner; and
maintain the changed suction power for the preset time.

10. The cleaner of claim 1, wherein the instructions, when executed by the one or more processors individually or collectively, further cause the cleaner to:
decrease suction power of the cleaner and an output of the brush motor according to a determination that the cleaner has been lifted up from the floor for the reference time or more.

11. A control method performed by a cleaner, the method comprising:
detecting a suction pressure value of air sucked into the cleaner;
detecting a driving current value of a brush motor of the cleaner;
determining whether the cleaner has been lifted up from a floor based on the suction pressure value and the driving current value; and
decreasing suction power of the cleaner by decreasing a rotation speed of the suction motor of the cleaner according to a determination that the cleaner has been lifted up from the floor for a reference time or more.

12. The method of claim 11, further comprising:
identifying a type of a floor on which the cleaner is placed based on the suction pressure value and the driving current value; and
changing the suction power of the cleaner to a strength of suction power corresponding to the identified type of the floor.

13. The method of claim 12,
wherein the changing of the suction power of the cleaner to the strength of suction power corresponding to the identified type of the floor comprises:
increasing or decreasing an output of the suction motor by applying current to the suction motor based on the strength of suction power corresponding to the identified type of the floor, and
wherein an output decrease rate when the output decreases is higher than an output increase rate when the output increases.

14. The method of claim 12, further comprising:
displaying the identified type of the floor and the strength of suction power.

15. The method of claim 12, further comprising:
displaying a guide user interface (UI) for guiding setting of a suction power automatic mode, based on reception of a user input of changing suction power a reference number of times or more within a reference time.

16. The method of claim 12, further comprising:
displaying a guide user interface (UI) for guiding a change of the suction power of the cleaner to the strength of suction power corresponding to the type of the floor, and
changing the suction power of the cleaner to the strength of suction power corresponding to the type of the floor, according to reception of a user input to the guide UI.

17. The method of claim 16, further comprising:
displaying, when the identified type of the floor has changed, the guide UI for guiding a change of the suction power of the cleaner to the strength of suction power corresponding to the type of the floor.

18. The method of claim 11, further comprising:
detecting a pattern of the suction pressure value;
changing, according to a determination that the pattern of the suction pressure value represents a preset pattern, a strength of suction power of the cleaner to a strength of suction power corresponding to the preset pattern; and
maintaining the changed suction power for a preset time.

19. One or more non-transitory computer-readable storage media storing one or more computer programs including computer-executable instructions that, when executed by one or more processors of a cleaner individually or collectively, cause the cleaner to perform operations, the operations comprising:
detecting a suction pressure value of air sucked into the cleaner;
detecting a driving current value of a brush motor of the cleaner;
determining whether the cleaner has been lifted up from a floor based on the suction pressure value and the driving current value; and
decreasing suction power of the cleaner by decreasing a rotation speed of the suction motor of the cleaner according to a determination that the cleaner has been lifted up from the floor for a reference time or more.

20. The one or more non-transitory computer-readable storage media of claim 19, the operations further comprising:
identifying a type of a floor on which the cleaner is placed based on the suction pressure value and the driving current value; and
changing the suction power of the cleaner to a strength of suction power corresponding to the identified type of the floor.
